(19) United States
(12) Patent Application Publication
(10) Pub. No.: US 2021/0284794 A1
(43) Pub. Date: Sep. 16, 2021

(54) Chemically Uniform Dilatant Materials

(71) Applicant: WiSys Technology Foundation, Inc., Madion, WI (US)

(72) Inventor: John P. Droske, Amherst, WI (US)

(21) Appl. No.: 16/610,661

(22) PCT Filed: May 7, 2018
(86) PCT No.: PCT/US2018/031377

§ 371 Date: Nov. 4, 2019

Related U.S. Application Data
(60) Provisional application No. 62/502,013, filed on May 5, 2017.

(51) Int. Cl. C08G 63/688

(52) U.S. Cl. CPC C08G 63/6886

(57) ABSTRACT

A series of materials that exhibit a range of dilatant properties have been synthesized. The materials show good transparency and are chemically uniform, that is, they consist of a single chemical component. The dilatant properties likely are due to the presence of both aggregated and non-aggregated forms of the oligomers. The degree of dilatancy can be modified by adjusting the monomer composition. The range of dilatant properties, good transparency, and single chemical component nature of the dilatant samples make these materials of particular interest.

### CROSS-REFERENCE TO RELATED APPLICATIONS

The present application claims priority from U.S. Provisional Patent Application Ser. No. 62/502,013, filed on May 5, 2017, the entirety of which is expressly incorporated herein by reference.

### FIELD OF THE INVENTION

The present invention relates to bis(hydroxyalkyl) mercaptosuccinates and derivatives thereof, and methods for producing and using the same.

### BACKGROUND AND SUMMARY OF THE INVENTION

Dilatant materials exhibit Non-Newtonian properties. One interesting property is the ability to change from soft and moldable to hard upon impact. Because of this, they have potential as materials for body armor and sports equipment.
1. Dilatant materials are not common. Those that have been reported are colloidal mixtures and multicomponent systems, such as Silly Putty™.
2. What is reported here is the synthesis and preliminary characterization of a single chemical component dilatant material.

According to one exemplary embodiment of the invention, a series of materials that exhibit a range of dilatant properties have been synthesized. The materials show good transparency and are chemically uniform, that is, they consist of a single chemical component. The dilatant properties likely are due to the presence of both aggregated and non-aggregated forms of the oligomers. The degree of dilatancy can be modified by adjusting the monomer composition. The range of dilatant properties, good transparency, and single chemical component nature of the dilatant samples make these materials of particular interest.

### BRIEF DESCRIPTION OF THE DRAWINGS

The drawings illustrate the best mode currently contemplated of practicing the present invention.

In the drawings:

FIG. 1 is a graph of the ¹HNMR spectra of compounds I, II, III, and IV formed according to the disclosure.

FIG. 2 is a graph of the ¹HNMR spectra of propylene glycol and compound IV formed according to the disclosure.

FIG. 3 is a photograph illustrating scattering of light from a purple laser with a compound sample on left, water on right.

FIG. 4 is a photograph illustrating the transparency of a dilatant material sample.

FIG. 5 are photographs of a dilatant material sample before dropping, immediately after dropping and after reformation after dropping.

### DETAILED DESCRIPTION

The following is an exemplary scheme (Scheme I) for the synthesis of some of the exemplary embodiments of the dilatant materials of the disclosure:

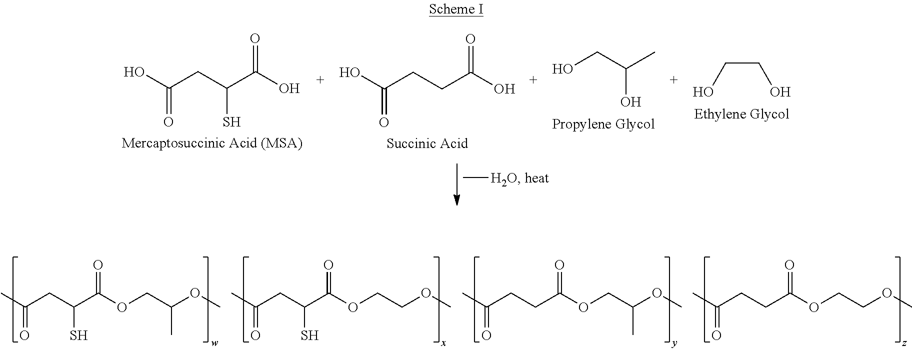

where each of W, X, Y and Z can vary from 0 to 1, e.g., as molar fractions or ratios of the relative amounts of the monomers present in the resulting dilatant material, with the sum of all values for W, X, Y and Z being equal to 1. For example, W=0.25, X=0.25, Y=0.25, and Z=0.25 if equimolar amounts of each of the four monomers was used at the beginning of the reaction and W=1.0 (X, Y, and Z=0) if only MSA and propylene glycol were used at the beginning of the reaction.

### Synthesis of Poly(1,2-propylenemercaptosuccinate) or Compound IV

To a round bottom flask equipped for distillation and magnetic stirring was added 15.0395 g (0.1000 moles) of mercaptosuccinic acid and 7.6216 g (0.1000 moles) of propylene glycol. The flask was placed in an oil bath and the system was purged with nitrogen gas for about five minutes to remove excess oxygen. The gas flow was reduced to a low rate and the reaction mixture was heated for four hours at 155° C. After cooling, the system was equipped for vacuum distillation. The reaction mixture was heated for eight hours under reduced pressure (˜100 mm Hg) to give poly(1,2-propylenemercaptosuccinate) (6.4249 g, 83%). Transfer of the viscous mixture to a sample vial was facilitated by gentle heating with a heat gun. The structure was confirmed by ¹HNMR spectroscopy.

### Batch Synthesis of Poly(1,2-propylenemercaptosuccinate) or Compound IV

To a 4-necked, two piece reaction flask equipped for simple distillation and with a stainless steel stir shaft and Teflon stir blade and vacuum bearing was added 434.1 g of 2-mercaptosuccinic acid (MSA, 2.891 mol) and 220.0 g of 1,2-propanediol (2.891 mol). The flask was purged for five minutes and then maintained under slowly flowing nitrogen gas while heated and stirred for 4 hours at 155° C. After cooling to room temperature, the flask was equipped for vacuum distillation and stirred for 4 additional hours at 155° C. under reduced pressure (˜250 Torr). To facilitate transfer, the viscous product was removed from the flask while warm giving a near quantitative yield.

### Synthesis of 75:25 Poly(1,2-propylenemercaptosuccinate)-co-(1,2-propylenesuccinate) or Compound II

The above procedure was followed except 3.8122 g (0.0500 moles) of propylene glycol, 1.4795 g (0.0125 moles) succinic acid, and 5.6429 g (0.0375 moles) mercaptosuccinic acid were used to give 6.8578 g (94%) of product.

### Synthesis of 50:50 Poly(2-propylenemercaptosuccinate)-co-(1,2-propylenesuccinate) or Compound III

The above procedure was followed except 3.8149 g (0.0254 moles) mercaptosuccinic acid, 3.0089 g (0.0254 moles) succinic acid, and 3.8047 g (0.0508 moles) propylene glycol were used to give 6.2859 g (91%) of product.

### Synthesis of Poly(1,2-propylenesuccinate) or Compound I

The above procedure was followed except 3.8192 g (0.0502 moles) propylene glycol and 5.9269 g (0.0502 moles) succinic acid were used to give 8.7573 g (91%) of product.

### Synthesis of 50:50 Poly(1,2-propylenemercaptosuccinate)-co-1,2 ethylenemercaptosuccinate) or Compound V

The above procedure was followed except 7.7052 g (0.0513 moles) mercaptosuccinic acid, 1.9248 g (0.0253 moles) propylene glycol, and 1.6165 g (0.0260 moles) ethanediol were used to give 6.5386 g (86%) of product.

The following is another exemplary scheme (Scheme II) for the synthesis of some of the exemplary embodiments of the dilatant materials of the disclosure:

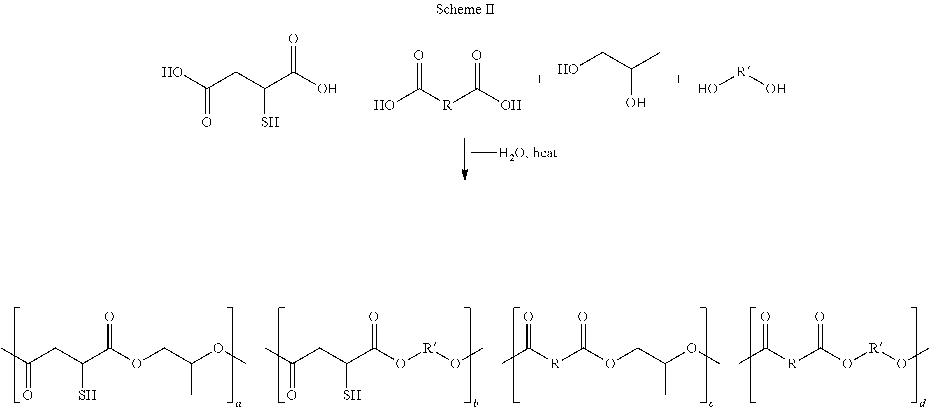

where a, b, c and d can vary from 0 to 1, e.g., as ratios of the relative amounts of the monomers present in the resulting dilatant material, with the sum of all values for a, b, c and d being equal to 1. Also, R and R′ are each selected from the group of alkylene, alkenylene, heteroalkylene, heteroalkenylene, haloalkylene, haloalkenylene, cycloaklyene, cycloalkenylene, arylene or heteroarylene. Further, the total initial molar quantity of the diacids is equivalent to the total initial molar quantity of diols.

Table 1 shows the compounds created using the synthesis processes I-V, and their corresponding dilatant properties:

TABLE 1
Starting Monomers, Compositions and Properties and of Compounds I-V

| | | | Propylene | Ethane | Resulting | |
|---|---|---|---|---|---|---|
| Compound | MSA | SA | Glycol | Diol | Composition | Observation |
| I | 0 | 100 | 100 | 0 | Only y | Not dilatant |
| II | 50 | 50 | 100 | 0 | 50w:50y | Moderately |
| | | | | | | dilatant |
| III | 75 | 25 | 100 | 0 | 75w:25y | Intermediately |
| | | | | | | dilatant |
| IV | 100 | 0 | 100 | 0 | Only w | Strongly |
| | | | | | | dilatant |
| V | 100 | — | 50 | 50 | 50w:50x | Moderately |
| | | | | | | dilatant |

In Table 1, the values for MSA, SA propylene glycol and ethylene glycol are molar amounts for the starting components (for example, 50 MSA=0.50 mole fraction of MSA and 50 SA=0.50 mole fraction of SA) and the resulting composition expressed in terms of the ratio of the monomers in the dilatant composition formed thereby. The amount in the table divided by 100 will give the mole fraction of each component. For Compound I, 1.00 mole fraction of SA was allowed to react with an equimolar amount of propylene glycol (mole fraction of propylene glycol also=1.00). The lengths of the polymer chains are such that they have a number-average molecular weight of about 1500 to 2000 amu.

### Experimental:

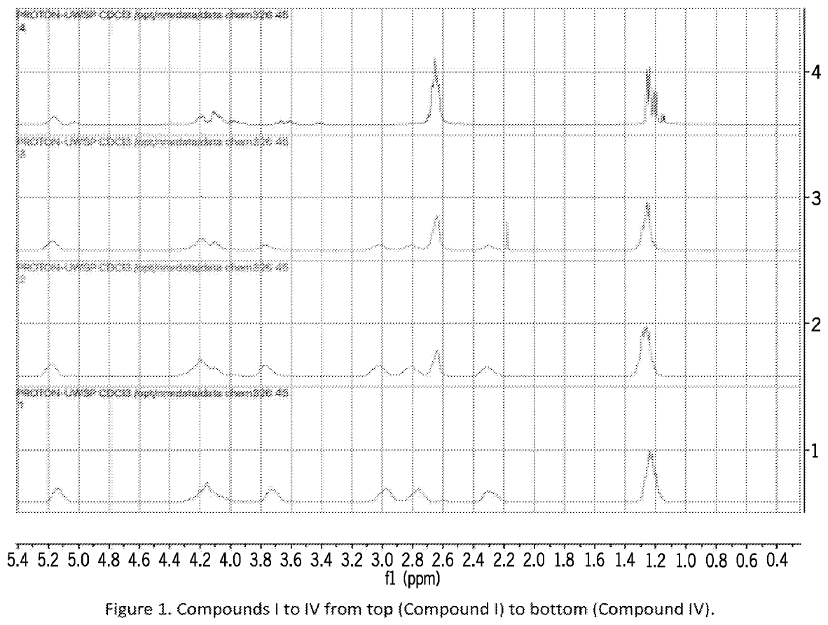

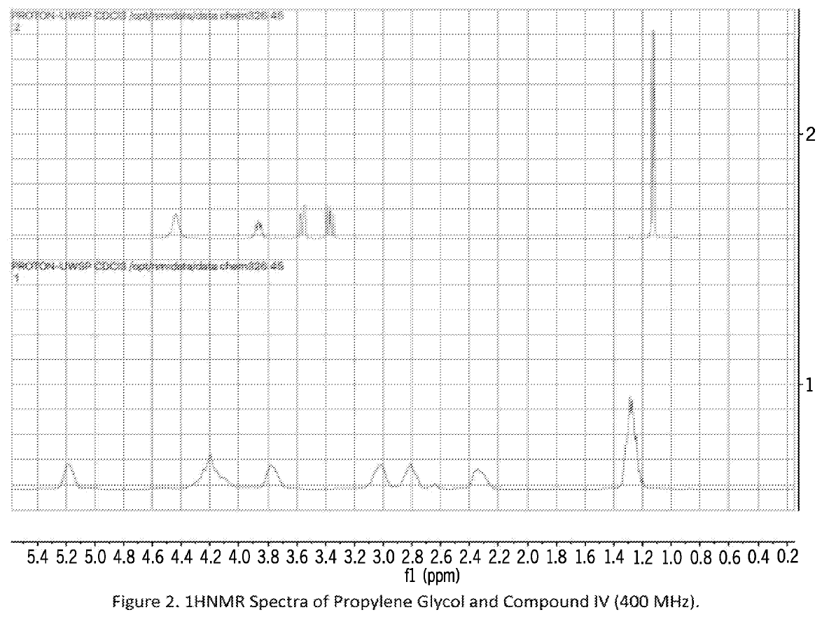

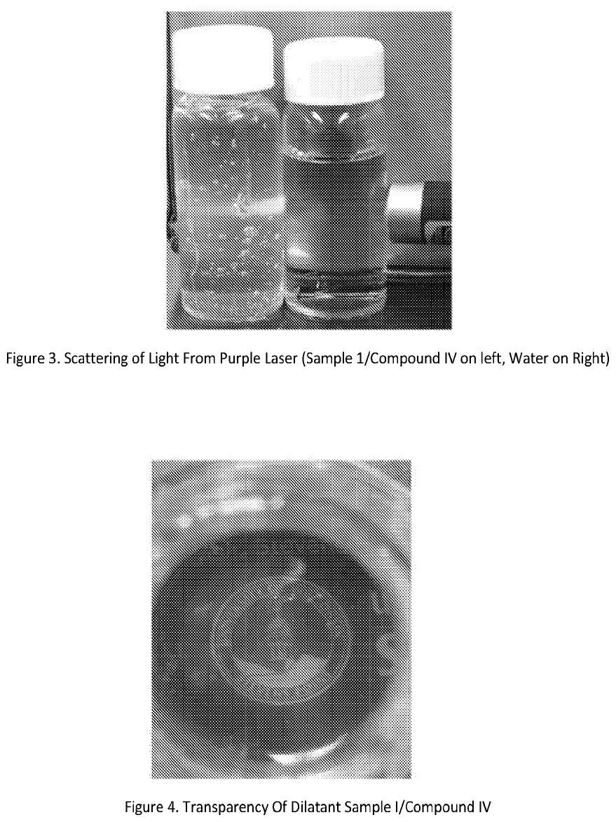

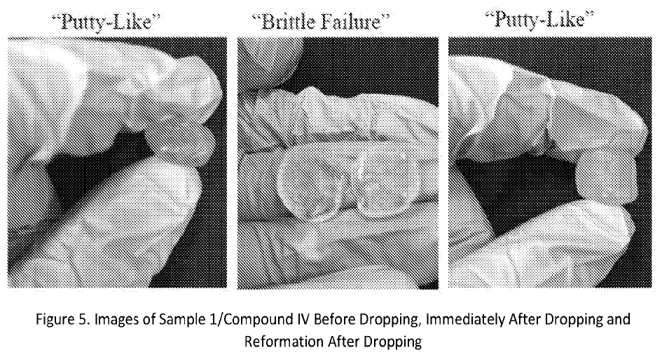

Comparison of ¹HNMR spectra of pure propylene glycol and Compound IV confirmed that propylene glycol is used up completely in the reaction. This is evidenced by the lack of peaks at 1.12, 3.37, 3.55, 3.87, and 4.44 ppm in spectra of the oligomers (FIG. 2). As expected, the diastereotopic hydrogens of mercaptosuccinic acid were observed at 2.6 ppm and 3.0 ppm in oligomers II, III, and IV (FIG. 1). The relative amounts of components w and y in oligomers II, III, and IV were determined by ¹HNMR spectroscopy. These were consistent with the expected oligomer composition based on the starting quantities of monomers. This structure confirmation and the lack of appreciable residual monomers or other components confirmed that each sample contained only the intended oligomer. The samples likely contain both aggregates and free oligomer as evidenced by scattering of laser light passed through the sample (FIG. 3). The maximum degree of dilatancy was observed when only mercaptosuccinic acid and propylene glycol were used as monomers. Sample I, which is corresponds to Compound IV, exhibited strong dilatant properties and cracked upon impact even at low velocity (FIG. 5). Even though the sample exhibited brittle failure when thrown, it can be molded like putty before and after impact. The dilatant properties lessen at elevated temperatures, likely due to breakdown of aggregates when heated.

Synthesis of poly(1,2-1-methylethylene-2-mercaptosuccinate). In one particular example of a dilatant compound of the present disclosure, to a round bottom flask equipped with a condenser and with magnetic stirring, was added 3.2863 grams (0.043190 moles) of 1,2-propanediol and 6.4788 g (0.043149 moles) of mercaptosuccinic acid. The flask was purged with nitrogen and then maintained under a slowly flowing nitrogen atmosphere. The reaction mixture was heated at 150° C./hour to 155° C. and then maintained at 155° C. for 4 hours. After cooling to room temperature, the flask was equipped for vacuum distillation. The resulting resin was heated under reduced pressure (<0.075 mm Hg) at 155° C. for an additional 4 hours. The structure was confirmed by ¹HNMR spectroscopy.

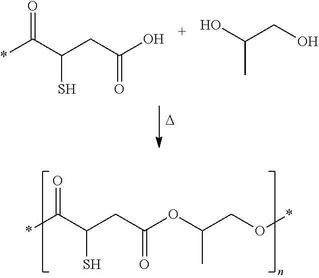

where n is approximately equal to 10.

Brief characterization: The resultant poly(1,2-1-methylethylene-2-mercaptosuccinate) material exhibits interesting non-newtonian dilatant properties. In particular, the material is flexible under usual conditions but it can be stretched into long fibers. For example, a small piece can be stretched out to a thin 11 foot long, free standing piece that was perfectly straight when held horizontal to the floor (i.e., straight similar to a 2×2 piece of lumber held horizontally). The stretched material readily softened as soon as it was touched.

However, upon fast stretching, the poly(1,2-1-methylethylene-2-mercaptosuccinate) material becomes very hard. A piece of the material can be readily molded into a small flexible ball. However, when thrown at a wall the material struck the wall with a solid crack, like a stone hitting the wall. After picking up the material, the material was soft again and showed no deformation at all, but was perfectly round. After subsequent trials, the material continued to exhibit this behavior but typically came back unaffected, i.e., round, but soft again. However, in one case (FIG. 5), the material broke in half, just as a rock might. But afterwards, the consistency of the material returned again to be soft like putty. In addition, as shown in FIG. 4 the poly(1,2-1-methylethylene-2-mercaptosuccinate is very transparent such that objects placed behind a container holding the dilatant material/fluid can be readily and clearly viewed through the fluid.

Additionally, the materials typically exhibit excellent adhesive properties. For example, all samples of the dilatant materials we have made containing MSA and a diol have been shown to adhere strongly to all glass, metal, wood, and plastics tested and are only removed from the surface with difficulty, i.e., usually involving some scraping of the material off of the surface, with the least adherence observed being to silicone polymers. As a result, this dilatant material may be useful as a next generation window glass adhesive. For example, current glass windshields are multi-layer with polymer adhesives between the glass layers. Potentially, the use of the dilatant material/polymer disclosed here in place of the current polymer adhesive would afford much higher levels of protection since our dilatant polymer strengthens as pressure is rapidly applied. This could be useful on all vehicles, but may be especially important for air or spacecraft or military and police vehicles. This material also may be useful in personal body armor or even for the preparation of polymeric projectiles. Further, the materials of the present disclosure exhibit these beneficial dilatant properties without being crosslinked.

The following references are expressly incorporated herein by reference for all purposes:
1. Thayer, A. Chemical and Engineering News. 2000, 78(48), 27. http://pubs.acs.org/cen/whatstuff/stuff/7848scit3.
2. http://duis.dartmouth.edu/2013/11/liquid-body-armor/#.WQfW8oWcUug
3. U.S. Pat. No. 9,187,596
4. U.S. patent application Ser. No. 13/873,073
   Various other embodiments of the present invention are contemplated as being within the scope of the filed claims particularly pointing out and distinctly claiming the subject matter regarded as the invention.

We claim:

1. A single chemical component dilatant material.

2. The material of claim 1 comprising aggregated and non-aggregated forms of oligomers of the material.

3. The material of claim 1 wherein the material has the following formula: 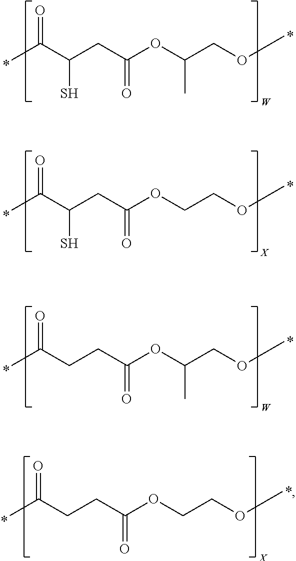
wherein W, X, Y, and Z each can vary from 0 to 1 with the sum of all being equal to 1.

4. The material of claim 1 wherein the material is poly(1,2-propylenemercaptosuccinate).

5. The material of claim 1 wherein the material is poly(1,2-propylenemercaptosuccinate)-co-(1,2-propylenesuccinate).

6. The material of claim 1 wherein the material is poly(1,2-propylenemercaptosuccinate)-co-(1,2-propylenesuccinate).

7. The material of claim 1 wherein the material is poly(1,2-propylenesuccinate).

8. The material of claim 1 wherein the material is poly(1,2-propylenemercaptosuccinate)-co-(1,2 ethylenemercaptosuccinate).

9. The material of claim 1 wherein the material is poly(1,2-1-methylethylene-2-mercaptosuccinate).

10. A method for forming single chemical component dilatant material with selected dilatant properties comprising the steps of:
a) adjusting a starting monomer composition;
b) reacting the monomer composition to form the single chemical component dilatant material with selected dilatant properties.

11. The method of claim 10 wherein the monomer composition consists of: 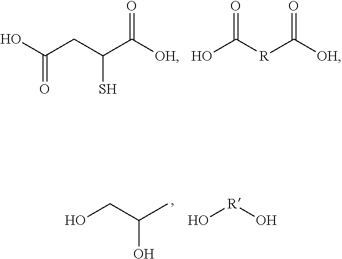
and combinations thereof; and
wherein R and R′ are each selected from the group of alkylene, alkenylene, heteroalkylene, heteroalkenylene, haloalkylene, haloalkenylene, cycloaklyene, cycloalkenylene, arylene or heteroarylene.

12. The method of claim 10 wherein the dilatant composition consists of: 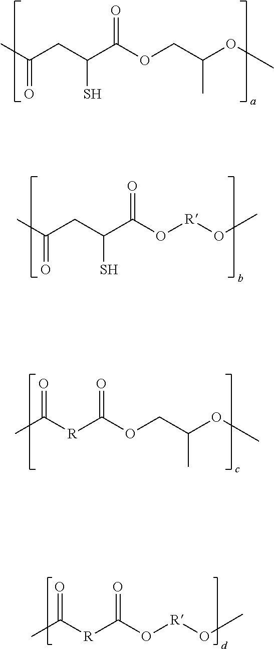
wherein a, b, c and d can vary from 0 to 1, with the sum of all values for a, b, c and d being equal to 1; and
wherein R and R′ are each selected from the group of alkylene, alkenylene, heteroalkylene, heteroalkenylene, haloalkylene, haloalkenylene, cycloaklyene, cycloalkenylene, arylene or heteroarylene.

13. A dilatant composition comprising: 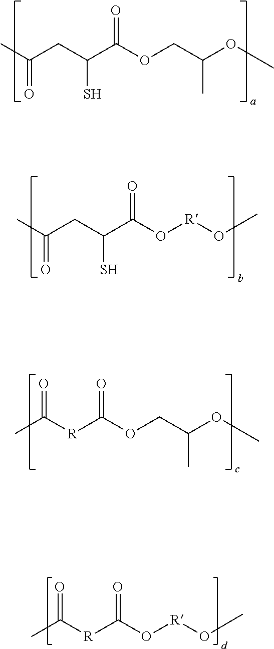
where a, b, c and d can vary from 0 to 1, with the sum of all values for a, b, c and d being equal to 1.
